(19) United States
(12) Patent Application Publication
(10) Pub. No.: US 2016/0039446 A1
(43) Pub. Date: Feb. 11, 2016

(54) DRIVING ASSIST UNIT OF TRUCK

(71) Applicant: KAYABA INDUSTRY CO., LTD., Tokyo (JP)

(72) Inventor: Shinichi SEKINE, Saitama (JP)

(73) Assignee: KAYABA INDUSTRY CO., LTD., Tokyo (JP)

(21) Appl. No.: 14/780,258

(22) PCT Filed: Mar. 26, 2014
(86) PCT No.: PCT/JP2014/058462

§ 371 Date: Sep. 25, 2015

(30) Foreign Application Priority Data
Mar. 26, 2013 (JP) 2013-064452

(51) Int. Cl. B62B 5/00; B62B 3/00

(52) U.S. Cl. CPC B62B 5/0073; B62B 5/0033; B62B 3/00

(57) ABSTRACT

A driving assist unit of a truck for assisting a driving force applied to the truck by a worker includes a unit body connected to the truck, the unit body being turnable with respect to the truck, an operation portion provided on the unit body, the operation portion being configured to input a driving force to the truck through the unit body by being pressed by the worker, and a driving wheel provided on the unit body, the driving wheel being rotatable in a longitudinal direction of the unit body, an assist force according to the operation of the operation portion being applied to the driving wheel.

### TECHNICAL FIELD

The present invention relates to a driving assist unit of a truck for assisting a driving force to be applied to the truck by a worker.

### BACKGROUND ART

Generally, when a heavy cargo is loaded on a truck used in a factory or the like, the worker needs to push the truck with a large force at start of conveyance, which is a heavy labor.

JP2008-126900A discloses an electric truck provided with a driving device for driving the truck through a connecting member. In this electric truck, the driving device is connected to the truck through the connecting member with one end connected to the truck, the connecting member being capable of swing around a horizontal axis.

### SUMMARY OF INVENTION

However, in the electric truck described in JP2008-126900A, a driving wheel of the driving device is provided, capable of turning around a vertical axis. Thus, a configuration for enabling turning of the driving wheel is needed, and a structure of the driving device is complicated.

The present invention has an object to simplify the structure of the driving assist unit of a truck.

According to an aspect of the present invention, a driving assist unit of a truck, configured to assist a driving force applied to the truck by a worker, includes a unit body connected to the truck, the unit body being turnable with respect to the truck, an operation portion provided on the unit body, the operation portion being configured to input driving force to the truck through the unit body by being pressed by the worker, and a driving wheel provided on the unit body, the driving wheel being rotatable in a longitudinal direction of the unit body, an assist force according to the operation of the operation portion being applied to the driving wheel.

### BRIEF DESCRIPTION OF DRAWINGS

FIG. 1 is a perspective view of a driving assist unit of a truck and the truck according to an embodiment of the present invention.

FIG. 2 is a side view in FIG. 1.

FIG. 3 is a rear view in FIG. 1.

FIG. 4 is a plan view in FIG. 1.

FIG. 5 is a perspective view of the driving assist unit of the truck according to the embodiment of the present invention.

FIG. 6 is a perspective view illustrating an internal structure of the driving assist unit of the truck according to the embodiment of the present invention.

FIG. 7 is a side view in FIG. 5.

### DESCRIPTION OF EMBODIMENTS

A driving assist unit (hereinafter referred to simply as “assist unit”) 100 of a truck according to an embodiment of the present invention will be described below by referring to the attached drawings.

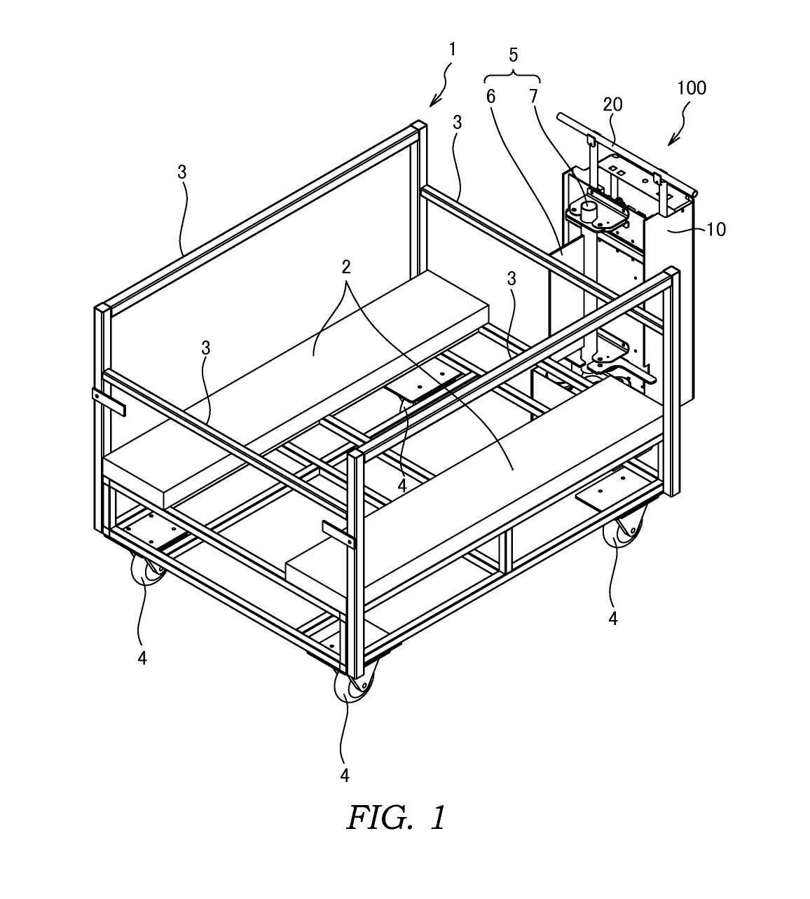

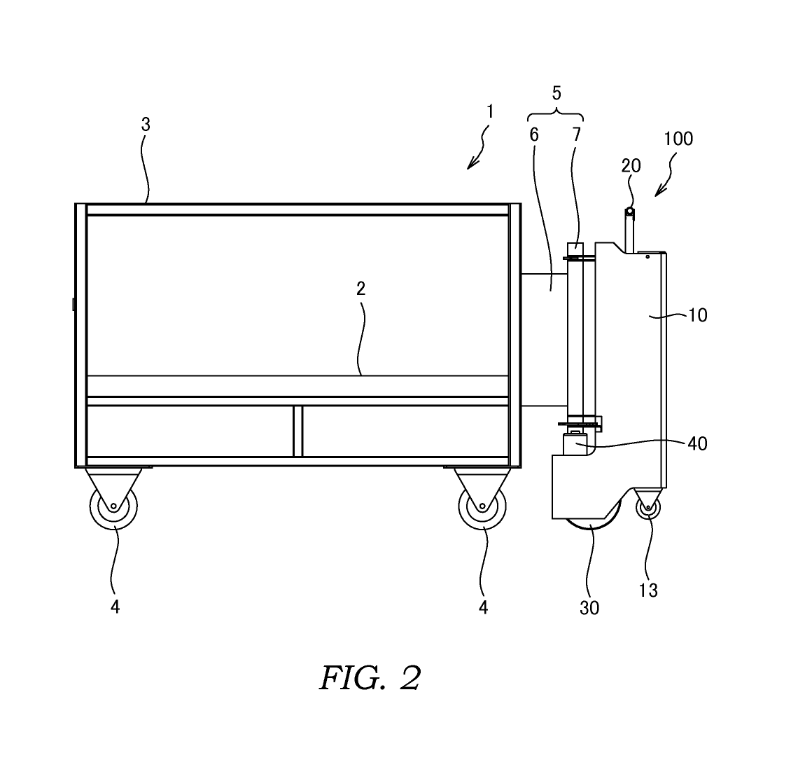

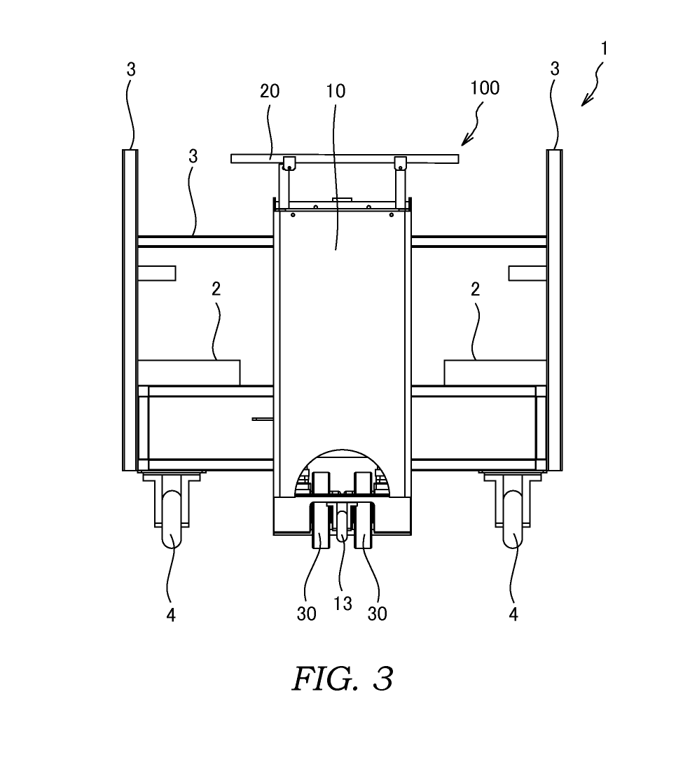

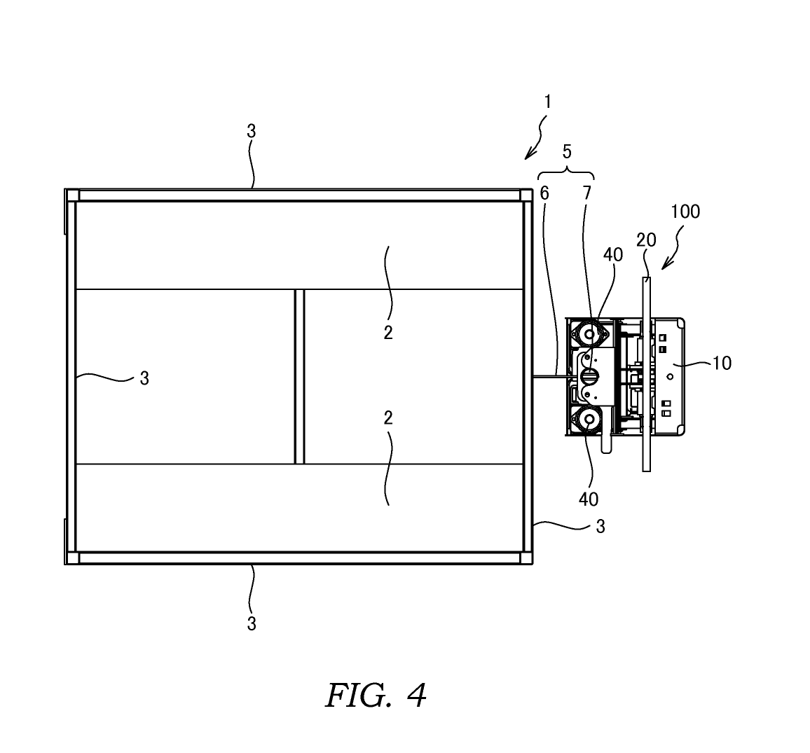

First, by referring to FIGS. 1 to 4, a truck 1 to which the assist unit 100 is connected will be explained.

The truck 1 is used for conveying a heavy article in a factory or the like, for example. As illustrated in FIG. 1, the truck 1 is a cage truck having a deck 2 formed having a rectangular shape, standing portions 3 provided vertically upward from four sides of an outer periphery of the deck 2, and four wheels 4 supporting four corner parts of the deck 2, respectively. The truck 1 is movable by rotation of the wheels 4.

Since it is only necessary that the truck 1 can convey a cargo loaded thereon, it is not limited to a cage truck. The truck 1 may be a handcart on which a handle is provided vertically only on one side of the deck 2 or a hand-lift whose deck is elevated up/down by an operation by a worker, for example.

On the deck 2, a cargo is loaded. In this embodiment, the deck 2 is a pair of rectangular plates split right and left. The deck 2 may be a rectangular single plate provided on the whole surface.

The wheels 4 are universal wheels directed toward a traveling direction at all times during traveling. All the four wheels 4 do not have to be universal wheels but a pair of wheels 4 away from the assist unit 100 may be fixed wheels, while only the pair of wheels 4 close to the assist unit 100 may be universal wheels. By setting the pair of wheels 4 away from the assist unit as the fixed wheels as above, straight traveling ability of the truck 1 is improved.

On the truck 1, a connecting member 5 for connecting the assist unit 100 is mounted on the standing portion 3 on a side of the deck 2.

The connecting member 5 has a bracket 6 fixed to the standing portion 3 and a connecting rod 7 provided on a free end of the bracket 6.

The bracket 6 is welded to the standing portion 3. Instead of welding, the bracket 6 may be mounted by bolting. When the bracket 6 is to be bolted to the standing portion 3, the connecting member 5 can be mounted on the truck 1 easily. Moreover, since it is only necessary that the bracket 6 can be bolted, the assist unit 100 can be connected by mounting the connecting member 5 on an existing truck having various shapes.

The connecting rod 7 is a cylindrical rod member provided by protruding to an outside from the truck 1 by a length of the bracket 6. The connecting rod 7 is provided perpendicularly to the ground surface. The connecting rod 7 is connected to the truck 1 through the bracket 6 between a position where an upper hook mechanism 11 which will be described later is engaged and a position where a lower hook mechanism 12 which will be described is engaged. On the connecting rod 7, the assist unit 100 is mounted. The connecting rod 7 may be a solid round rod having a circular cross section instead of a cylindrical shape.

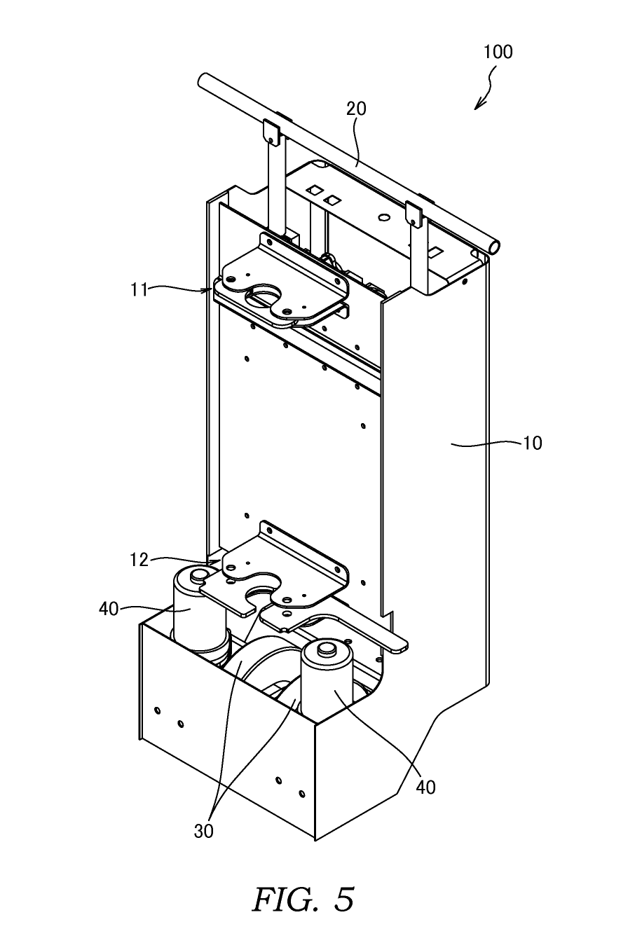

Subsequently, the assist unit 100 will be explained by referring to FIGS. 5 to 7.

The assist unit 100 is to assist the driving force applied to the truck 1 by the worker. The assist unit 100 has a unit body 10 connected to the truck 1, capable of turning, an operation handle 20 as an operation portion capable of inputting a driving force to the truck 1 through the unit body 10 by being pressed by the worker, and driving wheels 30 provided on the unit body 10, rotatably only in a longitudinal direction of the unit body 10 and to which an assist force according to the operation of the operation handle 20 is applied.

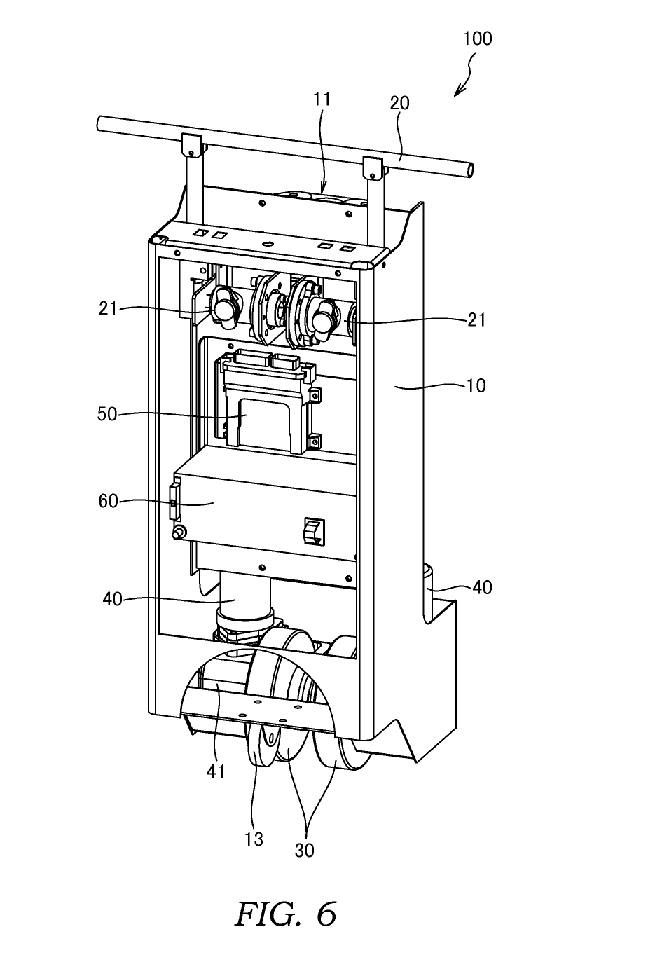

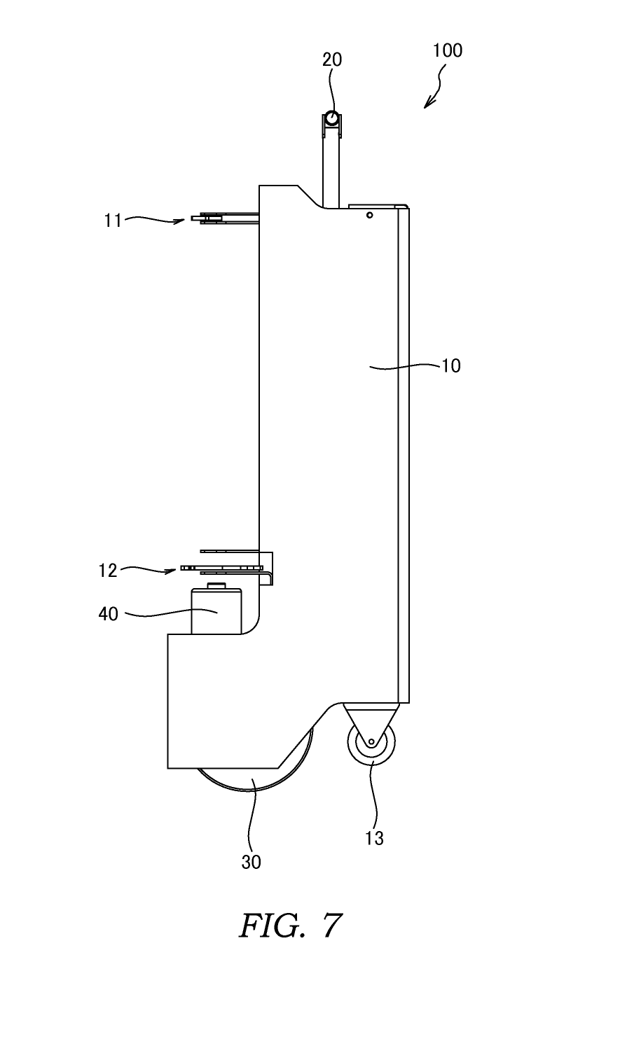

The unit body 10 is formed having a vertically long box shape and is supported by the driving wheels 30. The unit body 10 has the upper hook mechanism 11 and the lower hook mechanism 12 which are engaged with the connecting rod 7. Moreover, in the unit body 10, an auxiliary wheel 13 (see FIGS. 6 and 7) not grounded in a state in which the assist unit 100 is connected to the truck 1 is provided.

The upper hook mechanism 11 is engaged with the connecting rod 7 manually by the worker. On the other hand, the lower hook mechanism 12 can be engaged with the connecting rod 7 in a single operation only by pressing the assist unit 100 onto the truck 1. The assist unit 100 is connected to the truck 1 by holding of the connecting rod 7 by the upper hook mechanism 11 and the lower hook mechanism 12.

The auxiliary wheel 13 is a fixed wheel provided away from the driving wheels 30 in a longitudinal direction and rotatable only in the same direction as that of the driving wheels 30. The auxiliary wheel 13 is used by being grounded when the assist unit 100 is removed from the truck 1 and moved as a single body. Specifically, the worker can ground the auxiliary wheel 13 by tilting the assist unit 100 having been removed from the truck 1 longitudinally and can move the assist unit 100 in a state in which three wheels, that is, the pair of driving wheels 30 and the auxiliary wheel 13 are grounded. Thus, stable movement of the assist unit 100 as a single body can be realized.

If the single driving wheel 30 is provided, a pair of the auxiliary wheels 13 is provided. As a result, similarly to the case in which the pair of driving wheels 30 is provided, the assist unit 100 can be stably moved as a single body with the three wheels being grounded.

The operation handle 20 is a handle provided on the unit body 10 and pressed by the worker. The operation handle 20 is a rod material horizontally extended in the right-and-left direction of the unit body 10. The operation handle 20 is connected to an upper part of the unit body 10 on the right and left thereof. As a result, a driving force inputted by operation of the operation handle 20 by the worker is transmitted to the truck 1 through the unit body 10.

The driving wheels 30 are provided unable of being steered and provided toward the longitudinal direction of the unit body 10. The driving wheels 30 are provided in a pair spaced from each other on right and left of the unit body 10. The driving wheels 30 are juxtaposed on right and left by sandwiching a turning center of the unit body 10. In this embodiment, the driving wheels 30 are provided in a pair but instead, the single driving wheel 30 may be provided.

Moreover, as illustrated in FIG. 6, the assist unit 100 includes a torque sensor 21 as a torque detection portion for detecting a driving torque inputted from the operation handle 20, an electric motor 40 for applying an assist force according to the driving torque detected by the torque sensor 21 to the driving wheels 30, a controller 50 for controlling the electric motor 40 in accordance with the driving torque detected by the torque sensor 21, and a battery 60 as a power supply device.

The torque sensor 21, the controller 50, the battery 60, and the electric motor 40 are arranged by being vertically arranged in order from the top in the unit body 10. As a result, the assist unit 100 can be formed with a compact shape.

The torque sensors 21 are provided in a pair in the unit body 10 and detect a driving torque inputted to each of the right and left two spots of the unit body 10. The torque sensor 21 is electrically connected to the controller 50 and outputs an electric signal according to the detected driving torque to the controller 50.

The torque sensor 21 includes a torsion bar (not shown) connecting the operation handle 20 to the unit body 10 and twisted by the driving force inputted from the operation handle 20 and also for transmitting the driving force to the unit body 10 and a potentiometer (not shown) for outputting the electric signal according to the torsion of the torsion bar and detects the driving torque on the basis of the torsion of the torsion bar. By changing the torsion bar, operation feeling by the worker can be also changed in accordance with a loaded load of the truck 1 without changing the other members.

The electric motor 40 is electrically connected to the controller 50 and rotated in accordance with the electric signal inputted from the controller 50. The electric motors 40 are provided in a pair and apply an assist force independently to each of the driving wheels 30.

The electric motor 40 is disposed so that its rotating shaft is oriented in a direction perpendicular to the ground. The electric motor 40 is provided outside of each of the pair of driving wheels 30. As a result, an interval between the pair of driving wheels 30 can be made small. Thus, a rotation radius of the driving wheel 30 is made small, and a moment required for the worker to rotate the assist unit 100 can be made small. Therefore, handling of the assist unit 100 by the worker is facilitated.

Between the driving wheel 30 and the electric motor 40, a warm transmission 41 as a transmission for reducing a speed of the rotation of the electric motor 40 and for changing a rotating direction and transmitting it to the driving wheel 30 is provided.

The controller 50 is mounted on the unit body 10. The controller 50 is for controlling the assist unit 100 and is constituted by a microcomputer provided with a CPU (Central Processing Unit), a ROM (Read Only Memory), a RAM (Random Access Memory), and an I/O interface (input/output interface). The RAM stores data in processing of the CPU, the ROM stores a control program of the CPU and the like in advance, and the I/O interface is used for input/output of information with respect to connected devices. By operating the CPU, the RAM and the like in accordance with a program stored in the ROM, control of the assist unit 100 is realized.

The controller 50 controls each of the right and left electric motors 40 in accordance with each of the driving torques detected by the right and left torque sensors 21 and applies an assist force to the right and left driving wheels 30. Specifically, the controller 50 controls the left-side electric motor 40 in accordance with the driving torque detected by the left-side torque sensor 21 and controls the right-side electric motor 40 in accordance with the driving torque detected by the right-side torque sensor 21. As a result, an assist force for advancing and retreating as well as linearly advancing, turning around or turning the assist unit 100 is applied.

The battery 60 is mounted on the unit body 10. The battery 60 is a battery cell for driving the controller 50 and for supplying a DC power to the electric motor 40 on the basis of control by the controller 50.

Subsequently, an action of the assist unit 100 will be explained.

First, a case in which the truck 1 is to be advanced or retreated linearly through the assist unit 100 will be explained. Here, an instance in which the assist unit 100 pushes the truck 1 is referred to as advance, while an instance in which the truck 1 is towed is referred to as retreat.

When the worker pushes the operating handle 20 with both hands in parallel, the assist unit 100 linearly advances the truck 1. In this case, the driving force inputted into the unit body 10 as the operation handle 20 is pushed is substantially the same on both right and left ends of the operation handle 20. Thus, the driving torque detected by the right and left torque sensors 21 are substantially the same.

When the right and left torque sensors 21 detect the same driving torque, the controller 50 instructs to apply the same assist force to the right and left driving wheels 30 from the right and left electric motors 40. As a result, the same assist force is applied to the right and left driving wheels 30.

Therefore, the assist unit 100 can linearly advance the truck 1 while it is faced with the same direction as the truck 1 without turning since the assist force of the electric motor 40 is applied to the driving force applied by the worker.

When the truck 1 is to be linearly retreated, the direction in which the operation handle 20 is pushed becomes the opposite, and only the rotating direction of the electric motor 40 becomes opposite, while the other actions are the same as those of the case of linear advancement.

Subsequently, a case in which the truck 1 is turned/made to travel through the assist unit 100 will be explained.

If the worker wants to differentiate the forces on the right and left used for pushing the operation handle 20, the assist unit 100 is turned/made to travel to left or right. At this time, the assist force applied to the right and left driving wheels 30 is different between the right and left electric motors 40.

Specifically, when the truck 1 is to be turned in the left direction, for example, the force for pushing the operation handle 20 with the right hand by the worker becomes larger than the force for pushing the operation handle 20 with the left hand. Thus, the driving torque detected by the right-side torque sensor 21 becomes larger than the driving torque detected by the left-side torque sensor 21.

The controller 50 gives an instruction that the assist force to be applied to the driving wheel 30 from the right-side electric motor 40 becomes larger than the assist force to be applied to the driving wheel 30 from the left-side electric motor 40. As a result, the assist force applied to the right-side driving wheel 30 becomes larger than the assist force applied to the left-side driving wheel 30.

Thus, the assist unit 100 is brought into a state of turning with respect to the truck 1. As described above, the assist unit 100 can apply not only the assist force for advancing or retreating the truck 1 but also a moment for turning the truck 1. Therefore, the assist unit 100 can turn/make the truck 1 travel as the assist force of the electric motor 40 is applied to the driving force applied by the worker.

The unit body 10 is connected to the truck 1, capable of turning. Moreover, the driving wheels 30 are provided on the unit body 10 rotatably only in the longitudinal direction. Thus, since the driving wheels 30 do not turn with respect to the unit body 10, a mechanism for turning the driving wheels 30 is not necessary. Therefore, a structure of the assist unit 100 of the truck 1 can be simplified.

Moreover, if a heavy article is loaded on the truck 1, the truck 1 can be moved by applying the assist force from the assist unit 100 on the basis of the operation of the worker. On the other hand, if a cargo mounted on the truck 1 is light or there is no cargo, the truck 1 can be moved only by the driving force by the worker without applying the assist force from the assist unit 100.

The right and left torque sensors 21 can detect a driving torque continuously and thus, the worker can control magnitude of the assist force in accordance with the force for pressing the operation handle 20.

According to the above-described embodiment, the following effects are exerted.

The unit body 10 is connected to the truck 1, capable of turning. The driving wheel 30 is provided on the unit body 10 rotatably only in the longitudinal direction and thus, it does not turn with respect to the unit body 10. Therefore, a mechanism for turning the driving wheel 30 is not needed and thus, the structure of the assist unit 100 can be simplified.

Moreover, the electric motor 40 and the warm transmission 41 are provided on the outer side of each of the pair of driving wheels 30. Thus, an interval between the pair of driving wheels 30 can be made small. Thus, since a rotation radius of the driving wheel 30 becomes small, a moment required for the worker to rotate the assist unit 100 can be made small. Therefore, handling of the assist unit 100 by the worker is facilitated.

Although an embodiment of the present invention has been described, the embodiment is merely one of application examples of the present invention and by no means limits the technical scope of the present invention to a specific configuration of the above-mentioned embodiment.

This application claims priority to Japanese Patent Application No. 2013-064452 filed in the Japanese Patent Office on Mar. 26, 2013, the entire contents of which are incorporated by reference herein.

1. A driving assist unit of a truck, configured to assist a driving force applied to the truck by a worker, comprising:
a unit body connected to the truck, the unit body being turnable with respect to the truck;
an operation portion provided on the unit body, the operation portion being configured to input driving force to the truck through the unit body by being pressed by the worker; and
a driving wheel provided on the unit body, the driving wheel being rotatable in a longitudinal direction of the unit body, an assist force according to the operation of the operation portion being applied to the driving wheel.

2. The driving assist unit of the truck according to claim 1, comprising:
a torque detection portion configured to detect a driving torque inputted from the operation portion;
an electric motor configured to apply an assist force according to the driving torque detected by the torque detection portion to the driving wheel; and
a controller configured to control the electric motor in accordance with the driving torque detected by the torque detection portion.

3. The driving assist unit of the truck according to claim 2, wherein
the torque detection portion includes a pair of torque detection portions, the torque detection portions detecting a driving torque inputted into each of right and left two spots of the unit body;
the driving wheel includes a pair of driving wheels, the driving wheels are spaced from each other on right and left of the unit body;
the electric motor includes a pair of electric motors, the electric motors applying an assist force independently to each of the driving wheels; and
the controller controls each of the right and left electric motors in accordance with each of the driving torques detected by the right and left torque detection portions.

4. The driving assist unit of the truck according to claim 3, wherein
the driving wheels are juxtaposed on right and left by sandwiching a turning center of the unit body; and
the electric motors are provided outside of the driving wheels.

5. The driving assist unit of the truck according to claim 1, further comprising:
an auxiliary wheel provided away from the driving wheel in a longitudinal direction, the auxiliary wheel being rotatable only in the same direction as that of the driving wheel and not grounded in a state connected to the truck.
